(19) United States
(12) Patent Application Publication
(10) Pub. No.: US 2009/0266720 A1
(43) Pub. Date: Oct. 29, 2009

(54) System for Protecting Objects from Reactive Atmospheric Gases

(76) Inventor: Mark L. Richards, Ogden, UT (US)

Correspondence Address: THOMPSON E. FEHR;GOLDENWEST CORPORATE CENTER, SUITE 300, 5025 ADAMS AVENUE, OGDEN, UT, 84403, US

(21) Appl. No.: 12/108,417

(22) Filed: Apr. 23, 2008

(51) Int. Cl. B65D 81/20; F17C 5/00; B65B 31/02

(52) U.S. Cl. 206/213.1; 141/5; 141/7; 141/10; 141/49; 141/66; 141/313

(57) ABSTRACT

A method and device for protecting rope (the term “rope” meaning herein a traditional rope or any other item that would be degraded by contact with oxygen) from reactive atmospheric gases, the basic method comprising introducing a gas having a greater molecular weight than does oxygen, O₂, termed a “heavy gas,” into a container having a low permeability to gas. Preferably, the heavy gas is an inert gas; and, most preferably, the heavy gas is argon. Also preferably, after introduction of the heavy gas, the heavy gas is removed, creating a vacuum within the container; and, most preferably the process of introduction and removal is repeated two times. Optionally, argon can be reintroduced into the container prior to sealing of the container. The device for protecting rope is, logically, the container and its contents resulting from the process just described.

### BACKGROUND OF THE INVENTION

1. Field of the Invention

This invention relates to methods and containers for protecting objects from reacting with atmospheric gases, especially a bag having very lower permeability for gases with such bag being filled with an inert gas and especially when the object is rope.

2. Description of the Related Art

The fibers which compose rope age, i.e., become less strong, because of interactions that occur when oxygen, organic material, or water is present.

No non-degrading coating has been found for rope. And absorbents placed within a closed container can absorb only so much oxygen.

Textiles, but not rope, have been vacuum packed for a long time.

Moreover, ethanol is used with fruits, and dry nitrogen has been used inside packages for foods. Nitrogen, however, becomes reactive at and above a temperature of 43° C. (110° F.). Consequently, since stored ropes may experience such temperatures, nitrogen is not a desirable component within a sealed package containing rope.

U.S. Pat. No. 4,550,026 is directed toward preserving food by placing it in an atmosphere which includes ethanol and one or more volatile aliphatic acids, suitable aliphatic acids including those aliphatic acids having from 2 to 6 carbon atoms. And U.S. Pat. No. 4,843,956 covers a system for providing and delivering a preservative gas such as carbon dioxide to an enclosure such as a palletized container for a perishable food product.

And, according to an article entitled “Modified Atmosphere Packaging and Material Gas Permeability,” which can be found at www.ferret.com.au, in contrast to vacuum packaging and nitrogen-filled packaging, modified atmosphere packaging employs low barrier material with a high permeability rate and uses carbon dioxide to restrain growth of putrid bacilli and fungi, oxygen to restrain the propagation of anaerobic bacilli and to maintain meat color and fresheners, and nitrogen or an inert gas, such as argon, to prevent package slump caused by gas, such as carbon dioxide, escaping.

The present inventor is, however, unaware of a gas—preferably, a gas having a greater molecular mass than does oxygen, O₂; even more preferably, such gas being an inert gas; and most preferably, such gas being argon—having been placed into a container to protect an item other than food, especially rope, from exposure to oxygen.

### BRIEF SUMMARY OF THE INVENTION

The present System for Protecting Objects from Reactive Atmospheric Gases introduces a gas having a greater molecular mass than oxygen into a container in order to displace oxygen for the preservation of any item that is degraded by oxygen, especially rope, in the container. Preferably, the introduced gas is an inert gas. Optionally, oxygen can be vacuumed from the container prior to the introduction of the gas having a greater molecular mass than oxygen. (Of course, when the oxygen is removed, other gases within the air which is normally in the container, such as nitrogen, are additionally removed.) Also optionally, the item to be preserved may be exposed to the gas having the greater molecular mass than oxygen prior to placement of such item in the container.

Having a gas with a greater molecular mass than oxygen facilitates the gas entering a gas-permeable item such as rope. When the gas with a greater molecular mass than oxygen is inert, such as argon, the most preferred gas with a greater molecular mass than oxygen, this further precludes deterioration caused by oxidation not only on the surface, but also internally. (Of course, for a non-gas-permeable item, the inert gas with a greater molecular mass than oxygen merely needs to surround the surface of such item.)

### BRIEF DESCRIPTION OF THE SEVERAL VIEWS OF THE DRAWING

FIG. 1 is a cutaway view from above a bag connected to an exterior vacuum and an exterior source of gas having a greater molecular weight than does oxygen.

FIG. 2 is a cutaway view from the side showing a bag connected to an exterior vacuum and an exterior source of gas with a greater molecular mass than oxygen.

FIG. 3 is a cutaway view from the front of a bag within a chamber which establishes a vacuum in the bag and fills the bag with gas having a greater molecular mass than oxygen.

FIG. 4 is a cutaway view from the side of a sealed bag containing gas having a greater molecular mass than oxygen and a coiled rope.

### DETAILED DESCRIPTION OF THE INVENTION

The present System for Protecting Objects from Reactive Atmospheric Gases places within a storage container 1 a rope 2 (or other item that would be degraded by contact with oxygen, especially a gas-permeable item but even including, although not limited to, ferrous metals that could rust), preferably (for the sake of economic desirability) a rope 2 coiled for storage. Oxygen is preferably removed from such container by the introduction into the container 1 of a gas 3 having a greater molecular mass than does oxygen, O₂; even more preferably, such gas 3 being an inert gas 3; and most preferably, such gas 3 being argon 3. Should one so desire, the oxygen could be vacuumed from the storage container 1 prior to the introduction of the gas 3 having a greater molecular mass than does oxygen.

Optionally, the rope 2 (For convenience, the term “rope” shall be used herein to mean a traditional rope or any other item that would be degraded by contact with oxygen, especially a gas-permeable item.) can be pre-filled with the gas 3 having a greater molecular weight than does oxygen by exposing the rope 2 to the gas 3 having a greater molecular weight than does oxygen in the storage container 1 or a chamber 4 filled with the gas 3 having a greater molecular weight than does oxygen. The more massive gas 3 molecules will displace oxygen molecules within the rope 2 due to entropy. If desired, though, the rope 2 can also be agitated or vibrated during the pre-filling process in order the expedite the exchange of the gas 3 having a greater molecular weight than does oxygen for oxygen, O₂.

The storage container 1 is preferably a bag 1. The lower the permeability of the bag 1 to gas, the better, consistent with economic concerns. In terms of low permeability, the most desirable bag 1 is a foil-lined bag 1. An optional item which it is, furthermore, desirable to contain within the bag 1 is a detector 5 that provides a visual signal in the presence of oxygen; and, for viewing, this would require a small transparent window 6 to be included within the structure of the bag 1 when the bag 1 is not transparent, such as a foil-lined bag 1, which is not transparent. Utilization of the window 6 would somewhat increase the permeability of the bag 1 to gas.

A bag 1 having an aluminum foil laminate and meeting military specifications is available from Techflex Packaging, LLC of Hawthorne, Calif. This bag 1 has the following four layers in its laminate: nylon, low-density polyethylene, aluminum foil, and polyethylene. It could be used to store a rope for twenty-five years with the present invention.

A six-ply polyethylene nylon bi-flex (having plastic layers with grains running in alternating directions) bag 1 is also available. The material could, for example, be produced in accordance with U.S. Pat. No. 4,095,012 or 4,351,876.

A new material, transparent aluminum oxide, can be laminated with nylon and low-density polyethylene and then covered with an outer layer to protect the structure of the bag 1 against ultraviolet radiation. Examples of such a bag are those of the Barrialox 1011EG series produced by Toray Industries, Inc. of Tokyo, Japan.

And, although not transparent, the Pakdry 1500 bag 1 manufactured by Impak Corporation of Los Angeles, Calif., and available online at www.sorbentsystems.com from Sorbent Systems, Inc. of Granada Hills, Calif., has a tensile strength of 735 pounds, a burst strength of 130 pounds per square inch, and a puncture strength of 38 pounds. Consequently, this bag 1 need not have such a high vacuum in it as is required by most other bags to protect contents that react with atmospheric gases.

As suggested above, the heart of the present invention is the use of a gas 3 having a greater molecular mass than does oxygen, O₂ (even more preferably, such gas 3 being an inert gas 3; and most preferably, such gas 3 being argon 3) within the sealed bag 1 in order to preserve the rope 2. The vacuum sealing is substantially the same as traditional vacuum sealing. (From this point forward, the generic term “heavy gas” 3 shall be used to mean a gas 3 having a greater molecular mass than does oxygen, O₂.)

Preferably, one end 7 and the sides 8 of the bag 1 are pre-sealed, as one having ordinary skill in the art would understand from the term “bag.”

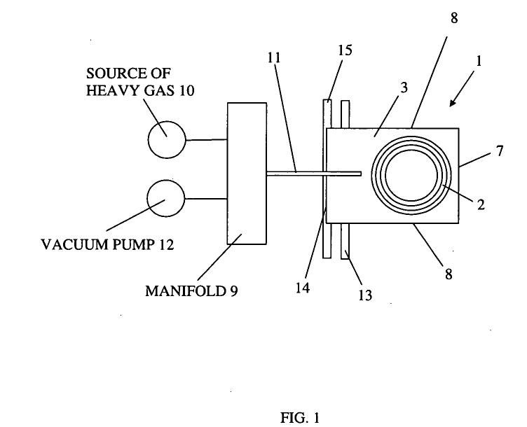

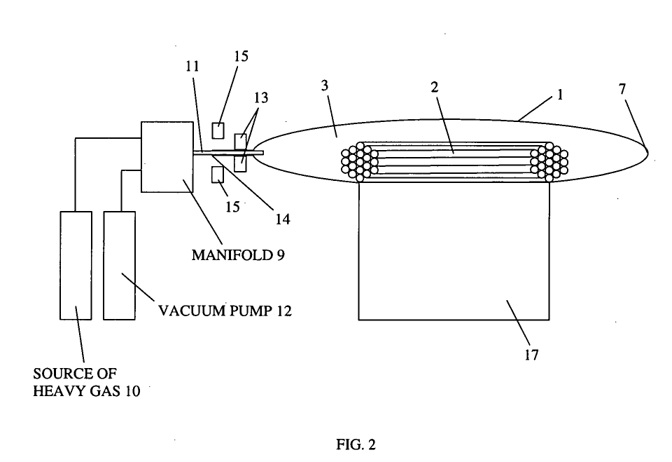

The bag 1 is flooded with the heavy gas 3. A manifold 9 that is well known in the art can be used, as shown in FIGS. 1 and 2, to take the heavy gas 3 from a traditional source 10 and introduce the heavy gas 3 into the bag 1 through an extendable and retractable tube 11 called a “snorkel.” The rope 2 is, during or after the introduction of the heavy gas 3 and preferably before sealing of the container 1, allowed to sit, or preferably agitated, within the bag 1. Preferably, the heavy gas 3 and any residual oxygen is then removed with a traditional vacuum pump 12, which is meant herein to include—but not necessarily to be limited to—a venture pump, that is traditionally connected to the manifold 9 and snorkel 11, thereby creating a vacuum in the bag 1; and, also preferably, the process of introducing and removing is repeated, preferably two times. Finally, the bag 1 is sealed.

A traditional clamping bar 13 holds, as shown most clearly in FIG. 2, the open end 14 of the bag 1 tightly around the snorkel 11 during introduction and removal to minimize the chance of oxygen entering the bag 1. And sealing is preferably accomplished with a traditional heating bar 15 that is moved to retain the open end 14 of the bag 1 at substantially the same time as the snorkel 11 and the clamping bar 13 are removed.

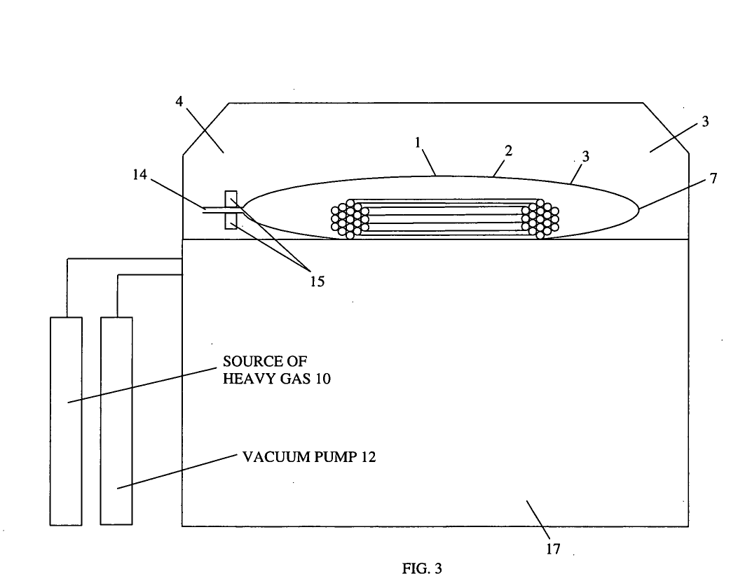

The process of introducing the heavy gas 3 and removing such heavy gas 3 together with any residual oxygen as well as the optional initial removal of oxygen and the optional exposure of the rope 2 to the heavy gas 3 prior to placement of the rope 2 in the bag 1 could, though, occur, as suggested above, within a chamber 4, portrayed in FIG. 3, such as those of the SC Series Vacuum Chamber Machines manufactured by and available from Promarks, Inc. of Rancho, Cucamonga, Calif., whose online address is www.promarksvac.com, in which case a heating bar 15 is used for sealing but no clamping bar 13 is necessary.

Preferably, the vacuum within the sealed bag 1 is at least that which would be sufficient to lift a column of mercury at least 61 centimeters (24 inches). If the bag 1 contains items other than a rope 2, such as a carabiner, the vacuum may have to be lower in order to avoid puncturing the bag 1.

Optionally, rather than vacuuming the bag 1 during the final cycle, enough heavy gas 3 to create a pressure within the bag 1 greater than atmospheric pressure, i.e., an overpressure situation, may be introduced into the bag 1 and left after sealing to assure that any minute leak will result in the heavy gas 3 leaving the bag 1, rather than oxygen entering the bag 1.

When overpressure is utilized for the storage of an item other that is not soft, a rigid container 1 can be preferable. Additionally, cycling with the heavy gas 3 in order to increase the introduction of heavy gas 3 into the item, as well as to remove residual oxygen, may not be necessary if the item (other than its surface) is substantially impervious to oxygen.

Furthermore, a less desirable—but still beneficial—alternative is simply to introduce heavy gas 3 into the bag 1 containing the rope 2 and then sealing the bag 1 either with or without creating a vacuum after the sealing and without removing oxygen prior to the introduction of the heavy gas 3.

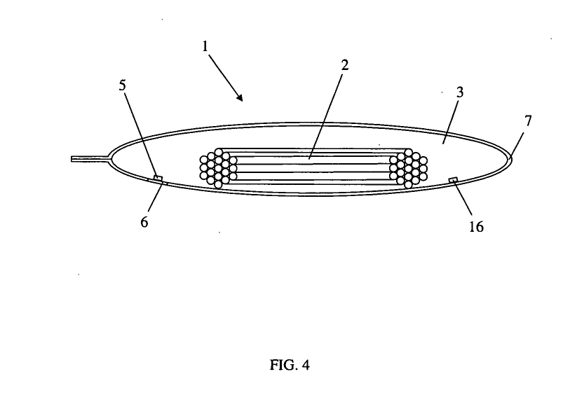

And a final desirable option is the placement within the bag 1 of an oxygen absorbent 16 (preferably, iron filings, a microsieve dessicant, or both), as illustrated in the sealed bag 1 of FIG. 4.

Moreover, with any structure used for introducing heavy gas 3 into the bag 1 it is preferable to have a support 17 for the bag 1.

As used herein, the term “substantially” indicates that one skilled in the art would consider the value modified by such terms to be within acceptable limits for the stated value. Also as used herein the term “preferable” or “preferably” means that a specified element or technique is more acceptable than another but not that such specified element or technique is a necessity.

I claim:

1. A method for protecting rope from reactive atmospheric gases, which comprises:
placing rope inside a container having a low permeability to gas;
introducing a heavy gas into the container to force oxygen from the container; and
then sealing the container.

2. The method for protecting rope from reactive atmospheric gases as recited in claim 1, further comprising:
agitating the rope inside the container before sealing the container but after commencing introducing the heavy gas and while the container contains heavy gas.

3. The method for protecting rope from reactive atmospheric gases as recited in claim 2, further comprising:
after introducing the heavy gas into the container but before sealing the container, removing the heavy gas from the container, leaving a vacuum in the container.

4. The method for protecting rope from reactive atmospheric gases as recited in claim 3, further comprising:
after removing the heavy gas from the container, introducing heavy gas into the container again.

5. The method for protecting rope from reactive atmospheric gases as recited in claim 3, further comprising:
repeating the introducing and subsequent removing of the heavy gas at least once.

6. The method for protecting rope from reactive atmospheric gases as recited in claim 5, further comprising:
after removing the heavy gas from the container a final time, introducing heavy gas into the container again.

7. The method for protecting rope from reactive atmospheric gases as recited in claim 3, wherein:
the container is a bag.

8. The method for protecting rope from reactive atmospheric gases as recited in claim 7, further comprising:
after removing the heavy gas from the container, introducing heavy gas into the container again.

9. The method for protecting rope from reactive atmospheric gases as recited in claim 7, further comprising:
repeating the introducing and subsequent removing of the heavy gas at least once.

10. The method for protecting rope from reactive atmospheric gases as recited in claim 9, further comprising:
after removing the heavy gas from the container a final time, introducing heavy gas into the container again.

11. The method for protecting rope from reactive atmospheric gases as recited in claim 7, wherein:
the heavy gas is an inert gas.

12. The method for protecting rope from reactive atmospheric gases as recited in claim 11, wherein:
the inert gas is argon.

13. The method for protecting rope from reactive atmospheric gases as recited in claim 11, further comprising:
after removing the heavy gas from the container, introducing heavy gas into the container again.

14. The method for protecting rope from reactive atmospheric gases as recited in claim 13, wherein:
the inert gas is argon.

15. The method for protecting rope from reactive atmospheric gases as recited in claim 11, further comprising:
repeating the introducing and subsequent removing of the heavy gas at least once.

16. The method for protecting rope from reactive atmospheric gases as recited in claim 15, wherein:
the inert gas is argon.

17. The method for protecting rope from reactive atmospheric gases as recited in claim 15, further comprising:
after removing the heavy gas from the container a final time, introducing heavy gas into the container again.

18. The method for protecting rope from reactive atmospheric gases as recited in claim 17, wherein:
the inert gas is argon.

19. The method for protecting rope from reactive atmospheric gases as recited in claim 3, wherein:
the heavy gas is an inert gas.

20. The method for protecting rope from reactive atmospheric gases as recited in claim 19, wherein:
the inert gas is argon.

21. The method for protecting rope from reactive atmospheric gases as recited in claim 19, further comprising:
after removing the heavy gas from the container, introducing heavy gas into the container again.

22. The method for protecting rope from reactive atmospheric gases as recited in claim 21, wherein:
the inert gas is argon.

23. The method for protecting rope from reactive atmospheric gases as recited in claim 19, further comprising:
repeating the introducing and subsequent removing of the heavy gas at least once.

24. The method for protecting rope from reactive atmospheric gases as recited in claim 23, wherein:
the inert gas is argon.

25. The method for protecting rope from reactive atmospheric gases as recited in claim 23, further comprising:
after removing the heavy gas from the container a final time, introducing heavy gas into the container again.

26. The method for protecting rope from reactive atmospheric gases as recited in claim 25, wherein:
the inert gas is argon.

27. The method for protecting rope from reactive atmospheric gases as recited in claim 2, wherein:
the container is a bag.

28. The method for protecting rope from reactive atmospheric gases as recited in claim 27, wherein:
the heavy gas is an inert gas.

29. The method for protecting rope from reactive atmospheric gases as recited in claim 28, wherein:
the inert gas is argon.

30. The method for protecting rope from reactive atmospheric gases as recited in claim 2, wherein:
the heavy gas is an inert gas.

31. The method for protecting rope from reactive atmospheric gases as recited in claim 30, wherein:
the inert gas is argon.

32. The method for protecting rope from reactive atmospheric gases as recited in claim 1, further comprising:
after introducing the heavy gas into the container but before sealing the container, removing the heavy gas from the container, leaving a vacuum in the container.

33. The method for protecting rope from reactive atmospheric gases as recited in claim 32, further comprising:
after removing the heavy gas from the container, introducing heavy gas into the container again.

34. The method for protecting rope from reactive atmospheric gases as recited in claim 32, further comprising:
repeating the introducing and subsequent removing of the heavy gas at least once.

35. The method for protecting rope from reactive atmospheric gases as recited in claim 34, further comprising:
after removing the heavy gas from the container a final time, introducing heavy gas into the container again.

36. The method for protecting rope from reactive atmospheric gases as recited in claim 32, wherein:
the container is a bag.

37. The method for protecting rope from reactive atmospheric gases as recited in claim 36, further comprising:
after removing the heavy gas from the container, introducing heavy gas into the container again.

38. The method for protecting rope from reactive atmospheric gases as recited in claim 36, further comprising:
repeating the introducing and subsequent removing of the heavy gas at least once.

39. The method for protecting rope from reactive atmospheric gases as recited in claim 38, further comprising:
after removing the heavy gas from the container a final time, introducing heavy gas into the container again.

40. The method for protecting rope from reactive atmospheric gases as recited in claim 36, wherein:
the heavy gas is an inert gas.

41. The method for protecting rope from reactive atmospheric gases as recited in claim 40, wherein:
the inert gas is argon.

42. The method for protecting rope from reactive atmospheric gases as recited in claim 40, further comprising:
after removing the heavy gas from the container, introducing heavy gas into the container again.

43. The method for protecting rope from reactive atmospheric gases as recited in claim 42, wherein:
the inert gas is argon.

44. The method for protecting rope from reactive atmospheric gases as recited in claim 40, further comprising:
repeating the introducing and subsequent removing of the heavy gas at least once.

45. The method for protecting rope from reactive atmospheric gases as recited in claim 44, wherein:
the inert gas is argon.

46. The method for protecting rope from reactive atmospheric gases as recited in claim 44, further comprising:
after removing the heavy gas from the container a final time, introducing heavy gas into the container again.

47. The method for protecting rope from reactive atmospheric gases as recited in claim 46, wherein:
the inert gas is argon.

48. The method for protecting rope from reactive atmospheric gases as recited in claim 32, wherein:
the heavy gas is an inert gas.

49. The method for protecting rope from reactive atmospheric gases as recited in claim 48, wherein:
the inert gas is argon.

50. The method for protecting rope from reactive atmospheric gases as recited in claim 48, further comprising:
after removing the heavy gas from the container, introducing heavy gas into the container again.

51. The method for protecting rope from reactive atmospheric gases as recited in claim 50, wherein:
the inert gas is argon.

52. The method for protecting rope from reactive atmospheric gases as recited in claim 48, further comprising:
repeating the introducing and subsequent removing of the heavy gas at least once.

53. The method for protecting rope from reactive atmospheric gases as recited in claim 52, wherein:
the inert gas is argon.

54. The method for protecting rope from reactive atmospheric gases as recited in claim 52, further comprising:
after removing the heavy gas from the container a final time, introducing heavy gas into the container again.

55. The method for protecting rope from reactive atmospheric gases as recited in claim 54, wherein:
the inert gas is argon.

56. The method for protecting rope from reactive atmospheric gases as recited in claim 1, wherein:
the container is a bag.

57. The method for protecting rope from reactive atmospheric gases as recited in claim 56, wherein:
the heavy gas is an inert gas.

58. The method for protecting rope from reactive atmospheric gases as recited in claim 57, wherein:
the inert gas is argon.

59. The method for protecting rope from reactive atmospheric gases as recited in claim 1, wherein:
the heavy gas is an inert gas.

60. The method for protecting rope from reactive atmospheric gases as recited in claim 59, wherein:
the inert gas is argon.

61. A method for protecting rope from reactive atmospheric gases, which comprises:
placing rope inside a bag having a low permeability to gas;
introducing argon into the bag to force oxygen from the bag;
then removing argon from the bag, leaving a vacuum in the bag;
after removing the heavy gas from the bag, introducing heavy gas into the bag again;
agitating the rope inside the bag before sealing the bag and on each occasion after argon has been introduced into the bag and while the bag still contains argon; and
then sealing the bag.

62. A method for protecting rope from reactive atmospheric gases, which comprises:
placing rope inside a bag having a low permeability to gas;
introducing argon into the bag to force oxygen from the bag;
then removing argon from the bag, leaving a vacuum in the bag;
repeating the introducing and subsequent removing of the argon at least once;
agitating the rope inside the bag before sealing the bag and on each occasion after argon has been introduced into the bag and while the bag still contains argon; and
then sealing the bag.

63. A method for protecting rope from reactive atmospheric gases, which comprises:
placing rope inside a bag having a low permeability to gas;
introducing argon into the bag to force oxygen from the bag;
then removing argon from the bag, leaving a vacuum in the bag;
repeating the introducing and subsequent removing of the heavy gas at least once;
after removing the argon from the bag a final time, introducing argon into the bag again;
agitating the rope inside the bag before sealing the bag and on each occasion after argon has been introduced into the bag and while the bag still contains argon; and
then sealing the bag.

64. A device for protecting rope from reactive atmospheric gases, which comprises:
a sealed container for the rope having low permeability to gas, said container comprising a structure; and
a heavy gas having been placed inside and removed from said container, leaving a vacuum in said container.

65. The device for protecting rope from reactive atmospheric gases as recited in claim 64, wherein:
said heavy gas is an inert gas.

66. The device for protecting rope from reactive atmospheric gases as recited in claim 65, wherein:
said inert gas is argon.

67. The device for protecting rope from reactive atmospheric gases as recited in claim 65, further comprising:
an oxygen absorbent within said container.

68. The device for protecting rope from reactive atmospheric gases as recited in claim 67, wherein:
said inert gas is argon.

69. The device for protecting rope from reactive atmospheric gases as recited in claim 67, wherein:
said container is transparent.

70. The device for protecting rope from reactive atmospheric gases as recited in claim 69, wherein:
said inert gas is argon.

71. The device for protecting rope from reactive atmospheric gases as recited in claim 67, further comprising:
a transparent window within the structure of said container.

72. The device for protecting rope from reactive atmospheric gases as recited in claim 71, wherein:
said inert gas is argon.

73. The device for protecting rope from reactive atmospheric gases as recited in claim 65, wherein:
said container is transparent.

74. The device for protecting rope from reactive atmospheric gases as recited in claim 73, wherein:
said inert gas is argon.

75. The device for protecting rope from reactive atmospheric gases as recited in claim 65, further comprising:
a transparent window within the structure of said container.

76. The device for protecting rope from reactive atmospheric gases as recited in claim 75, wherein:
said inert gas is argon.

77. The device for protecting rope from reactive atmospheric gases as recited in claim 64, further comprising:
an oxygen absorbent within said container.

78. The device for protecting rope from reactive atmospheric gases as recited in claim 77, wherein:
said container is transparent.

79. The device for protecting rope from reactive atmospheric gases as recited in claim 77, further comprising:
a transparent window within the structure of said container.

80. The device for protecting rope from reactive atmospheric gases as recited in claim 64, wherein:
said container is transparent.

81. The device for protecting rope from reactive atmospheric gases as recited in claim 64, further comprising:
a transparent window within the structure of said container.

82. A device for protecting rope from reactive atmospheric gases, which comprises:
a sealed, transparent container for the rope having low permeability to gas;
an oxygen absorbent within said container; and
argon having been placed inside and removed from said container, leaving a vacuum in said container.

83. A device for protecting rope from reactive atmospheric gases, which comprises:
a sealed container for the rope having low permeability to gas, said container comprising a structure;
a transparent window within the structure of said container;
an oxygen absorbent within said container; and
argon having been placed inside and removed from said container, leaving a vacuum in said container.

84. A device for protecting rope from reactive atmospheric gases, which comprises:
a sealed container for the rope having low permeability to gas, said container comprising a structure; and
a heavy gas having been placed inside and removed from said container, leaving a vacuum in said container, and the heavy gas then having been reintroduced into said container.

85. The device for protecting rope from reactive atmospheric gases as recited in claim 84, wherein:
said heavy gas is an inert gas.

86. The device for protecting rope from reactive atmospheric gases as recited in claim 85, wherein:
said inert gas is argon.

87. The device for protecting rope from reactive atmospheric gases as recited in claim 85, further comprising:
an oxygen absorbent within said container.

88. The device for protecting rope from reactive atmospheric gases as recited in claim 87, wherein:
said inert gas is argon.

89. The device for protecting rope from reactive atmospheric gases as recited in claim 87, wherein:
said container is transparent.

90. The device for protecting rope from reactive atmospheric gases as recited in claim 89, wherein:
said inert gas is argon.

91. The device for protecting rope from reactive atmospheric gases as recited in claim 87, further comprising:
a transparent window within the structure of said container.

92. The device for protecting rope from reactive atmospheric gases as recited in claim 91, wherein:
said inert gas is argon.

93. The device for protecting rope from reactive atmospheric gases as recited in claim 85, wherein:
said container is transparent.

94. The device for protecting rope from reactive atmospheric gases as recited in claim 93, wherein:
said inert gas is argon.

95. The device for protecting rope from reactive atmospheric gases as recited in claim 85, further comprising:
a transparent window within the structure of said container.

96. The device for protecting rope from reactive atmospheric gases as recited in claim 95, wherein:
said inert gas is argon.

97. The device for protecting rope from reactive atmospheric gases as recited in claim 84, further comprising:
an oxygen absorbent within said container.

98. The device for protecting rope from reactive atmospheric gases as recited in claim 97, wherein:
said container is transparent.

99. The device for protecting rope from reactive atmospheric gases as recited in claim 97, further comprising:
a transparent window within the structure of said container.

100. The device for protecting rope from reactive atmospheric gases as recited in claim 84, wherein:
said container is transparent.

101. The device for protecting rope from reactive atmospheric gases as recited in claim 84, further comprising:
a transparent window within the structure of said container.

102. A device for protecting rope from reactive atmospheric gases, which comprises:
a sealed, transparent container for the rope having low permeability to gas;
an oxygen absorbent within said container; and
argon having been placed inside and removed from said container, leaving a vacuum in said container, and the argon then having been reintroduced into said container.

103. A device for protecting rope from reactive atmospheric gases, which comprises:
a sealed container for the rope having low permeability to gas, said container comprising a structure;
a transparent window within the structure of said container;
an oxygen absorbent within said container; and
argon having been placed inside and removed from said container, leaving a vacuum in said container, and the argon then having been reintroduced into said container.
